(19) United States
(12) Patent Application Publication
(10) Pub. No.: US 2017/0241325 A1
(43) Pub. Date: Aug. 24, 2017

(54) DUAL FUEL ENGINE

(71) Applicant: Caterpillar Inc., Peoria, IL (US)

(72) Inventors: Yongxian Gu, West Lafayette, IN (US); Phillip J. Houtz, West Lafayette, IN (US); Keith A. IntVeld, East Lafayette, IN (US)

(73) Assignee: Caterpillar Inc., Peoria, IL (US)

(21) Appl. No.: 15/046,461

(22) Filed: Feb. 18, 2016

(51) Int. Cl. F02B 19/12; F02M 43/04; F02B 19/10

(52) U.S. Cl. CPC F02B 19/12; F02B 19/108; F02M 43/04

(57) ABSTRACT

A dual fuel engine is provided. The dual fuel engine includes an engine cylinder and a piston disposed within the engine cylinder. The dual fuel engine includes a cylinder head coupled to the engine cylinder and a fuel injector coupled to the cylinder head. The fuel injector is adapted to supply a first fuel to the engine cylinder. The dual fuel engine further includes a pre-combustion chamber coupled to the cylinder head at a predetermined distance from the fuel injector. The pre-combustion chamber is in fluid communication with the engine cylinder via at least one conduit and the pre-combustion chamber is adapted to receive a second fuel and an air mixture. The second fuel is different from the first fuel. The dual fuel engine further includes a spark plug structured and arranged within the pre-combustion chamber and the spark plug is adapted to ignite the second fuel within the pre-combustion chamber.

### TECHNICAL FIELD

The present disclosure relates to dual fuel engines, and more specifically, to a dual fuel engine with a pre-combustion chamber to ignite fuels.

### BACKGROUND

Heavy machines, such as excavators, wheel loaders, or track type tractors, have high power requirements, and therefore, require a diesel engine for efficient working. Consequently, due to high power requirements, such machines require a lot of diesel during operation, thereby increasing the operating costs of these machines. In addition to diesel, there are a number of other fuels available such as natural gas, which are lower in cost and have the potential for reducing the operating costs of the machines. However, a standard diesel engine is unable to utilize natural gas as a fuel, as the diesel engine with a single diesel injector cannot have stable natural gas combustion and meet emission targets. A standard diesel engine is therefore, unable to take advantage of low cost fuels such as natural gas.

Engines utilizing multiple types of fuels are known, for example, an engine that utilizes gasoline blended with natural gas as a fuel. However, such engines are not suitable for heavy machines due to high power requirements. Also, operating costs of the heavy machines powered by a gasoline engine are expected to be very high. Moreover, there can be violent combustion of the fuel mixture, if the quantity of natural gas exceeds a threshold amount. Therefore, there is a need for a dual fuel engine that runs on multiple fuels which can meet the emission targets, as well as reduce the operating costs.

U.S. Patent Publication Number U.S.20130104850 discloses an internal combustion engine which is adapted to utilize two fuels. The internal combustion engine includes an ignition chamber having a spark plug for igniting a first fuel and a fuel injector for injecting a second fuel, such as diesel. The pre-chamber is disposed at a center of an engine cylinder. However, the internal combustion engine disclosed in the reference is not a diesel engine, and is not suitable for applications such as construction machines. Moreover, an inefficient combustion of diesel is likely to occur in such an engine, which results into knocking in the engine. Therefore, there is a need for a dual fuel engine which can efficiently ignite the dual fuel, provide stable in cylinder combustion and meet the desired emission targets.

### SUMMARY OF THE DISCLOSURE

In one aspect of the present disclosure, a dual fuel engine is provided. The dual fuel engine includes an engine cylinder and a piston disposed within the engine cylinder. The dual fuel engine also includes a cylinder head coupled to the engine cylinder and a fuel injector coupled to the cylinder head. The fuel injector is adapted to supply a first fuel to the engine cylinder. The dual fuel engine further includes a pre-combustion chamber coupled to the cylinder head at a predetermined distance from the fuel injector. The pre-combustion chamber is in fluid communication with the engine cylinder via at least one conduit and the pre-combustion chamber is adapted to receive a second fuel and an air mixture. The second fuel is different from the first fuel. The dual fuel engine further includes a spark plug structured and arranged within the pre-combustion chamber and the spark plug is adapted to ignite the second fuel within the pre-combustion chamber.

Other features and aspects of this disclosure will be apparent from the following description and the accompanying drawings

### BRIEF DESCRIPTION OF THE DRAWINGS

FIG. 1 is a side view of the internal components of a dual fuel engine shown without the cylinder housing, in accordance with the concepts of the present disclosure;

FIG. 2 is a sectional view of a portion of the dual fuel engine having a pre-combustion chamber and a spark plug, shown in accordance with the concepts of the present disclosure; and

FIG. 3 is a flowchart of a method for operating the dual fuel engine, in accordance with the concepts of the present disclosure.

### DETAILED DESCRIPTION

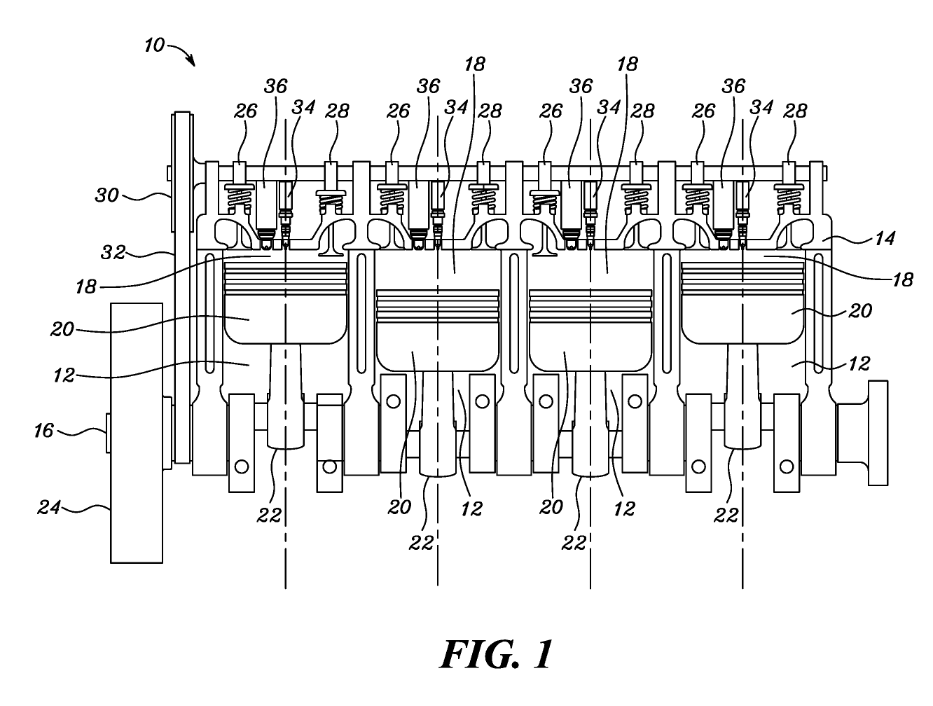

Referring to FIG. 1, the dual fuel engine 10 comprises an engine cylinder 12 coupled with a cylinder head 14. In an embodiment of the present disclosure, the dual fuel engine 10 includes four engine cylinders 12. The four engine cylinders 12 are mounted in a straight line, one after another, along a crankshaft 16. The engine cylinder 12 encloses a combustion chamber 18 and also, houses a piston 20 within the combustion chamber 18. The piston 20 is connected to the crankshaft 16 through a connecting rod 22. It would be apparent to one skilled in the art that the dual fuel engine 10 has one or more than one engine cylinders 12 for performing operation without departing from the meaning and scope of the disclosure.

The dual fuel engine 10 is adapted to move the piston 20 in a reciprocating motion. The piston 20 moves up within the engine cylinder 12 to a top dead center (TDC) position and moves down to a bottom dead center (BDC) position. The crankshaft 16 converts the reciprocating motion of the piston 20 into a rotational motion. The crankshaft 16 is coupled to a flywheel 24. The flywheel 24 imparts energy to the crankshaft 16 from time to time in order to keep the crankshaft 16 rotating.

The engine cylinder 12 further includes an inlet valve 26 and an exhaust valve 28 to allow entry and exit of a fuel and air mixture respectively in the combustion chamber 18. A camshaft 30 actuates the opening and closing of the inlet valve 26 and the exhaust valve 28. The camshaft 30 is connected to the crankshaft 16 through a belt 32. The belt 32 synchronizes the rotation of the camshaft 30 and the crankshaft 16 to open the inlet valve 26 and close the exhaust valve 28 during an inlet stroke and alternatively close the inlet valve 26 and open the exhaust valve 28 during an exhaust stroke. The dual fuel engine 10 employs various other components, such as filters, pumps, high pressure release valves, pressure regulators (not shown). It would be apparent to one skilled in the art that the dual fuel engine 10 is a diesel engine or “compression ignition internal combustion engine” that performs a variety of operations associated with a particular industry without departing from the meaning and scope of the disclosure.

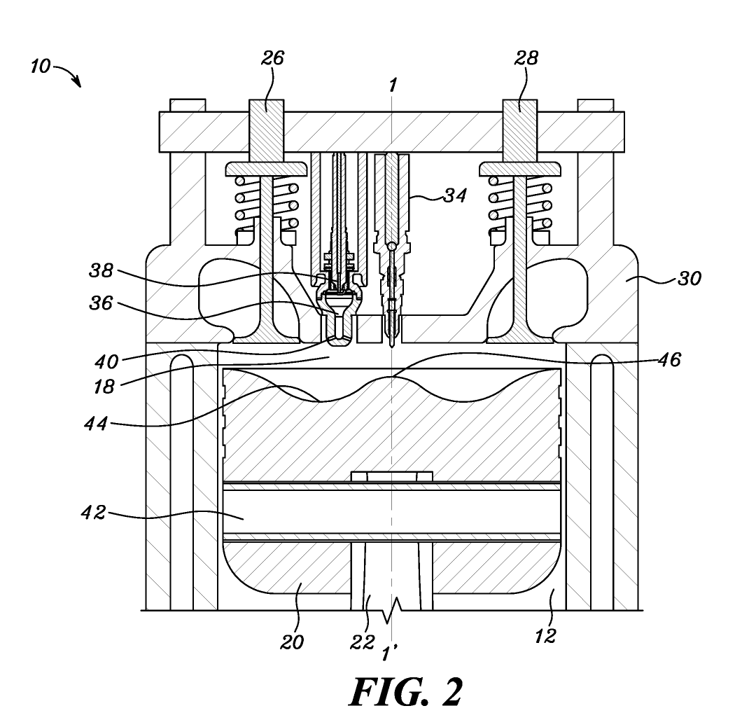

Referring to FIG. 2, the dual fuel engine 10 includes a fuel injector 34 centrally positioned within the cylinder head 14. In an embodiment, the fuel injector 34 is coaxial with respect to the engine cylinder 12 and is disposed within the cylinder head 14. The fuel injector 34 is adapted to supply a first fuel within the engine cylinder 12. In an embodiment, the first fuel supplied to the engine cylinder 12 is diesel or gasoline. Further, a second fuel pre-mixed with air is injected through the inlet valve 26 into the combustion chamber 18 of the engine cylinder 12. The second fuel is an alternate fuel, such as natural gas (also called Liquefied Natural Gas (LNG)), synthetic gas, liquefied petroleum gas (i.e. LPG), or hydrogen.

The pre-combustion chamber 36 is located at a predetermined distance from the fuel injector 34. The pre-combustion chamber 36 is in fluid communication with the combustion chamber 18 via at least one conduit 40. The pre-combustion chamber 36 remains in fluid communication with the combustion chamber 18 with any other form of passage, such as orifices, mesh, or channels. without departing from the meaning and scope of the disclosure.

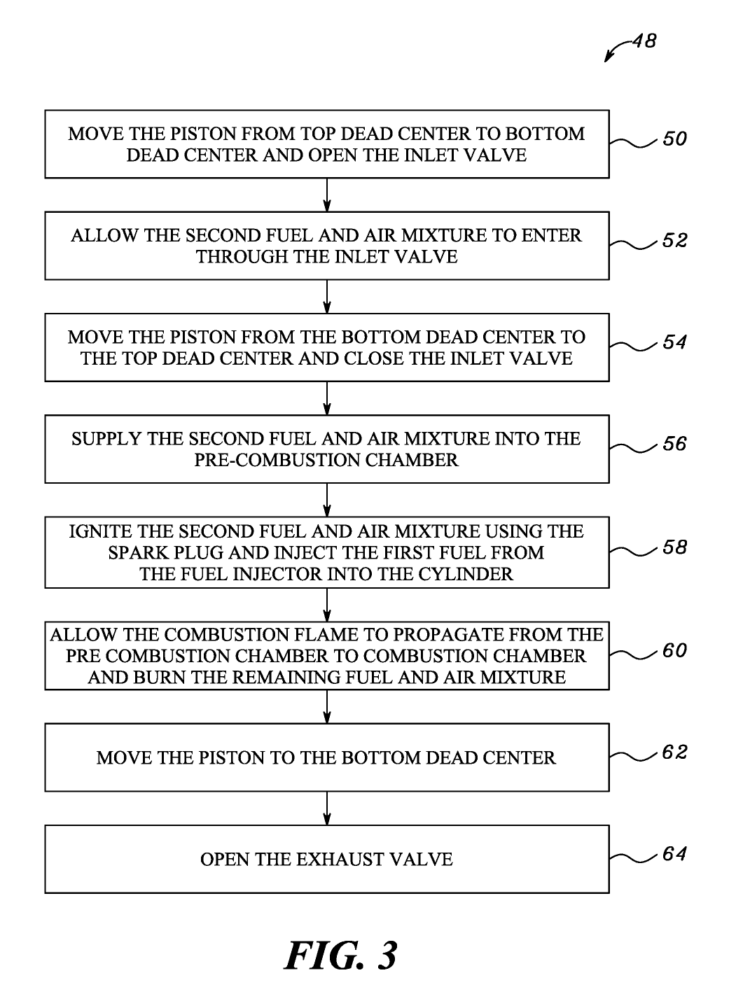

The pre-combustion chamber 36 includes a spark plug 38. A mixture of the second fuel and the air is ignited by the spark plug 38 within the pre-combustion chamber 36. The spark plug 38 delivers an electric current to ignite the mixture of the second fuel and the air within the pre-combustion chamber 36. The detailed combustion process is described in FIG. 3 below.

A gudgeon pin 42 connects the piston 20 and the connecting rod 22. As the piston 20 moves, the gudgeon pin 42 provides a bearing for the connecting rod 22. Further, the gudgeon pin 42 allows the connecting rod 22 to pivot relative to an axis 1/1′ of the engine cylinder 12. In an embodiment, the piston 20 features a crater 44 (i.e., a circular crater 44) and a protrusion 46. The protrusion 46 is of the shape of a cone. The fuel injector 34 is positioned above the center of the protrusion 46 of the piston 20.

Aside from the preferred embodiment or embodiments disclosed above, this disclosure is capable of other embodiments and of being practiced or being carried out in various ways. Thus, it is to be understood that the disclosure is not limited in its application to the details of construction and the arrangements of components set forth in the description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

### INDUSTRIAL APPLICABILITY

Referring to FIG. 3, a method 48 for operating the dual fuel engine 10 is described. The method 48 is described in conjunction with FIG. 1, and FIG. 2.

At step 50, the piston 20 moves from the top dead center to the bottom dead center in the combustion chamber 18 of the engine cylinder 12. During this process, the inlet valve 26 is opened.

At step 52, the inlet valve 26 is opened to allow a mixture of the second fuel and the air (also called the second fuel and air mixture) to enter into the combustion chamber 18. The piston 20 pulls the mixture of the second fuel and the air into the combustion chamber 18. A pull force is generated by a vacuum created in the combustion chamber 18, when the piston 20 moves from the top dead center to the bottom dead center as shown at step 50.

At step 54, the inlet valve 26 is closed as a sufficient amount of the mixture of the second fuel and the air is received into the combustion chamber 18. During this cycle, the piston 20 moves from the bottom dead center to the top dead center in the combustion chamber 18. The piston 20 compresses the mixture of the second fuel and the air inside the combustion chamber 18.

At a step 56, during the movement of the piston 20 towards the top dead center, a small portion of the mixture of the second fuel and the air enters the pre-combustion chamber 36 via the conduit 40. Further, as the piston 20 keeps moving towards the top dead center, the portion of the mixture of the second fuel and the air in the pre-combustion chamber 36 is also compressed.

At a step 58, the mixture of the second fuel and the air is ignited by the spark plug 38 within the pre-combustion chamber 36. The spark plug 38 delivers an electric current to ignite the mixture of the second fuel and the air within the pre-combustion chamber 36. As a result, the mixture of the second fuel and the air is ignited and a combustion flame gets generated in the pre-combustion chamber 36.

At step 60, the combustion flame then propagates to the combustion chamber 18 from the pre-combustion chamber 36 via the conduit 40 and burns the rest of the mixture of the second fuel and the air present in the combustion chamber 18. At the same time, the first fuel is injected from the fuel injector 34. In an embodiment, the injected volume of the first fuel is less than 4% of the total volume of the combined first fuel and the second fuel used in the dual fuel engine 10. It would be apparent to one skilled in the art that the injected volume of the first fuel with respect to a total volume can also vary for efficient operation of the dual fuel engine 10.

At step 62, when the combustion is completed, the piston 20 descends from the top dead center to the bottom dead center. High pressure created by the combustion inside the combustion chamber 18 drives the piston 20 downward supplying power to the crankshaft 16 via the connecting rod 22.

At step 64, the exhaust valve 28 is opened to remove the products of combustion and clear the combustion chamber 18 of the engine cylinder 12 to make the engine cylinder 12 ready for the next cycle of combustion.

The dual fuel engine 10 helps in saving the fuel cost and delivering more customer value. Further, the dual fuel engine 10 avoids violent fast burning in the transition substitution range, (˜50%-80%). Also, the natural gas substitution rate is approaching 100% instead of much lower rate limited by violent fast burning for the dual fuel mixture. The first fuel supplied is used to cool the fuel injector 34. The dual fuel engine 10 is utilized in a variety of machines, such as commercial vehicles, off-highway vehicles, cars, trucks, vans, boats, ships, power generators, or stationary gas compressors.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A dual fuel engine comprising:
an engine cylinder;
a piston disposed within the engine cylinder;
a cylinder head coupled to the engine cylinder;
a fuel injector coupled to the cylinder head, the fuel injector adapted to supply: a first fuel to the engine cylinder;
a pre-combustion chamber coupled to the cylinder head at a predetermined distance from the fuel injector, the pre-combustion chamber being in fluid communication with the engine cylinder via at least one conduit, the pre-combustion chamber is adapted to receive a second fuel and an air mixture, wherein the second fuel is different from the first fuel; and
a spark plug structured and arranged within the pre-combustion chamber, the spark plug configured to ignite the second fuel within the pre-combustion chamber.
